(19) United States
(12) Patent Application Publication
(10) Pub. No.: US 2025/0242569 A1
(43) Pub. Date: Jul. 31, 2025

(54) TEXTILE SLEEVE ASSEMBLY WITH ULTRASONICALLY WELDED ATTACHMENT FEATURES AND METHOD OF CONSTRUCTION THEREOF

(71) Applicant: FEDERAL-MOGUL POWERTRAIN LLC, Northville, MI (US)

(72) Inventors: STEVEN M. GALAMBA, WEST CHESTER, PA (US); DANIEL A. ROWCOTSKY, DRESHER, PA (US)

(21) Appl. No.: 19/040,625

(22) Filed: Jan. 29, 2025

Related U.S. Application Data
(60) Provisional application No. 63/627,059, filed on Jan. 30, 2024.

(51) Int. Cl. B32B 7/05; B29C 65/00; B29C 65/08; B29K 667/00; B29K 677/00; B29L 23/00; B29L 31/30; B32B 1/08; B32B 3/06; B32B 3/08; B32B 5/02; B32B 5/12; B32B 5/26; B60R 16/02; D03D 3/02; D03D 15/283; H01B 17/56; H01B 19/00

(52) U.S. Cl. CPC B32B 7/05; B29C 65/08; B29C 66/5326; B29C 66/729; B32B 1/08; B32B 3/06; B32B 3/08; B32B 5/024; B32B 5/12; B32B 5/263; D03D 3/02; D03D 15/283; H01B 17/56; H01B 19/00; B29K 2667/00; B29K 2677/00; B29L 2023/001; B29L 2031/30; B32B 2250/20; B32B 2262/0261; B32B 2262/0276; B32B 2571/00; B32B 2597/00; B32B 2605/00; B60R 16/0215; D10B 2331/02; D10B 2331/04; D10B 2505/12

(57) ABSTRACT

A textile sleeve assembly including a tubular textile wall with an outer surface and an inner surface bounding a cavity extending a longitudinal central axis for routing and protecting an elongate member therein. A textile fabric bonded to the outer surface of the tubular textile wall via a plurality of weld joints. The textile fabric having a pair of attachment features for attachment to spaced apart attachment members on a vehicle body and a closure member of a vehicle.

### CROSS-REFERENCE TO RELATED APPLICATION

This application claims the benefit of U.S. Provisional Application Ser. No. 63/627,059, filed Jan. 30, 2024, which is incorporated herein by reference in its entirety.

### BACKGROUND OF THE INVENTION

### 1. Technical Field

This invention relates generally to textile sleeves for protecting electrical members, and more particularly to textile sleeves having a textile fabric fixed thereto to facilitate attachment of the textile sleeve to both a body and a closure member of a vehicle.

### 2. Related Art

It is known to contain and protect an elongate member(s), such as wires and wire harnesses, for example, in protective textile sleeves, such as in vehicles, including automobiles, aircraft or aerospace craft, to provide protection to the elongate member against abrasion, fluid and thermal affects. It is further known to route the protective textile sleeve from a body of the vehicle to a moveable closure member of the vehicle, such as a vehicle swing door, hatch, hood, or otherwise. In order to provide the desired protection to the elongate member, the physical integrity of the textile sleeve must not be compromised, and the textile sleeve must not be moved or otherwise stressed beyond its physical capacity, such as by being stretched beyond a predetermined physical protective capacity length, which not only results in damage to the textile sleeve, but also the elongate member contained in the textile sleeve. Accordingly, what is desired is a textile sleeve that can be fixed in such a manner between a vehicle body and a closure member of a vehicle to avoid denigrating the protective capacity of the textile sleeve as the closure member is repeatedly opened and closed, while also avoiding damage from being caused to the elongate member contained in the fabric sleeve.

### SUMMARY OF THE INVENTION

One aspect of the invention provides a textile sleeve having a textile fabric bonded thereto, with the textile fabric having attachment features for attachment to spaced apart attachment members on a vehicle body and a closure member, wherein the textile fabric prevents overstressing of the textile sleeve and the elongate member contained therein.

Another aspect of the invention includes bonding the textile fabric to the textile sleeve via weld joints.

Another aspect of the invention includes providing the weld joints as ultrasonically welded weld joints.

Another aspect of the invention includes providing the attachment features on the textile fabric as reverse folded loops of the textile fabric.

Another aspect of the invention includes fixing the reverse folded loops of the textile fabric via weld joints

Another aspect of the invention includes providing the weld joints of the reverse folded loops as ultrasonically welded weld joints.

Another aspect of the invention includes providing the textile sleeve having lengthwise extending warp yarns and circumferentially extending weft yarns woven with one another.

Another aspect of the invention includes providing at least some of the warp and/or weft yarns of an ultrasonically weldable material.

Another aspect of the invention includes providing at least some of the warp and/or weft yarns of at least one of polyester and nylon.

Another aspect of the invention includes providing the entirety of the warp and/or weft yarns of at least one of polyester and nylon.

Another aspect of the invention includes providing the entirety of the warp and/or weft yarns of multifilaments of at least one of polyester and nylon.

Another aspect of the invention includes providing the textile fabric having lengthwise extending warp yarns and widthwise extending weft yarns woven with one another.

Another aspect of the invention includes providing at least some of the warp and/or weft yarns of the textile fabric of an ultrasonically weldable material.

Another aspect of the invention includes providing at least some of the warp and/or weft yarns of the textile fabric of at least one of polyester and nylon.

Another aspect of the invention includes providing the entirety of the warp and/or weft yarns of the textile fabric at least one of polyester and nylon.

Another aspect of the invention includes providing the entirety of the warp and/or weft yarns of multifilaments of the textile fabric of at least one of polyester and nylon.

Another aspect of the invention includes providing the textile sleeve and the textile fabric being formed of the same types of yarn.

In accordance with these and other aspects of the invention, a textile sleeve assembly having an elongate wall with an outer surface and an inner surface bounding a cavity extending a longitudinal central axis for routing and protecting an elongate member therein is provided. The textile sleeve assembly further includes a textile fabric bonded to the outer surface of the textile sleeve via weld joints. The textile fabric has a pair of attachment features for attachment to spaced apart attachment members on a vehicle body and a closure member of a vehicle.

In accordance with these and other aspects of the invention, the wall includes warp yarns extending generally parallel to the longitudinal central axis and weft yarns extending generally transversely to the warp yarns.

In accordance with these and other aspects of the invention, the textile fabric includes warp yarns extending generally parallel to the longitudinal central axis and weft yarns extending generally transversely to the warp yarns, wherein at least some of the yarns of the wall and/or textile fabric are provided as ultrasonically weldable material.

In accordance with another aspect of the invention, at least some of the yarns of the wall and the textile fabric are provided as weldable material.

In accordance with another aspect of the invention, the entirety of the yarns of the wall and the textile fabric are provided as weldable material.

In accordance with another aspect of the invention, at least some of the yarns of the wall and the textile fabric are provided as polyester or nylon.

In accordance with another aspect of the invention, the entirety of the yarns of the wall and the textile fabric are provided as polyester or nylon.

In accordance with another aspect of the invention, the pair of attachment features are loops formed by material of the textile fabric reverse folded back into bonded relation with the textile fabric.

In accordance with another aspect of the invention, the pair of loops are formed at opposite ends of the textile fabric.

In accordance with another aspect of the invention, opposite ends of the textile wall extend beyond the pair of attachment features of the textile fabric.

In accordance with another aspect of the invention, a protective sleeve and door strap assembly includes a tubular textile wall with an outer surface and an inner surface bounding a cavity extending a longitudinal central axis for routing and protecting an elongate member therein, and a textile door strap bonded to the outer surface of the tubular textile wall via a plurality of weld joints. The textile door strap has a pair of attachment features configured for attachment to spaced apart attachment members on a vehicle body and a closure member of a vehicle.

In accordance with another aspect of the disclosure, a method of constructing a protective sleeve and door strap assembly is provided. The method includes, interlacing yarn to form a tubular textile wall having an outer surface and an inner surface bounding a cavity extending a longitudinal central axis for routing and protecting an elongate member therein. Further, interlacing yarn to form a flat wall of textile fabric extending lengthwise between opposite ends and reverse folding the opposite ends into engagement with the flat wall of textile fabric and bonding the opposite ends to the flat wall of textile fabric to form pair of loops configured for attachment to spaced apart attachment members on a vehicle body and a closure member of a vehicle. Further; welding the flat wall of textile fabric to the outer surface of the tubular textile wall via a plurality of weld joints.

In accordance with a further aspect of the disclosure, the method can further include forming at least a pair of the plurality of weld joints including a first weld joint and a second weld joint spaced from one another along the textile flat wall of textile fabric a first length, and forming a portion of the tubular textile wall extending from the first weld joint to the second weld joint having a second length, wherein the second length is greater than the first length, thereby ensuring the portion of the tubular textile wall extending from the first weld joint to the second weld joint is always maintained in a non-tensioned, slack state, and thus, preventing tension from being transferred from the flat wall of textile fabric to the elongate member.

### BRIEF DESCRIPTION OF THE DRAWINGS

These and other aspects, features and advantages will become readily apparent to those skilled in the art in view of the following detailed description of presently preferred embodiments and best mode, appended claims, and accompanying drawings, in which:

FIG. 1A is perspective view of a vehicle body of a motor vehicle and a closure member of the motor vehicle shown in a fully opened position with a textile sleeve assembly constructed in accordance with one aspect of the invention extending between the vehicle body and the closure member and protecting an elongate member therein against exposure to external environmental elements, abrasion, and tension;

FIG. 1B is side view of the textile sleeve assembly of FIG. 1A;

FIG. 2A is a schematic perspective view of a tubular textile wall of the textile sleeve assembly of FIG. 1B;

FIG. 2B is a schematic plan view of a textile strap of the textile sleeve assembly of FIG. 1B;

FIG. 3A is a schematic fragmentary plan view of the tubular textile wall of FIG. 2A and of the textile fabric of FIG. 2B in accordance with one aspect of the disclosure;

FIG. 3B is a schematic fragmentary plan view of the tubular textile wall of FIG. 2A and of the textile fabric of FIG. 2B in accordance with another aspect of the disclosure;

FIG. 3C is a schematic fragmentary plan view of the tubular textile wall of FIG. 2A and of the textile fabric of FIG. 2B in accordance with another aspect of the disclosure; and

FIG. 3D is a schematic fragmentary plan view of the tubular textile wall of FIG. 2A and of the textile fabric of FIG. 2B in accordance with another aspect of the disclosure.

### DETAILED DESCRIPTION OF PREFERRED EMBODIMENTS

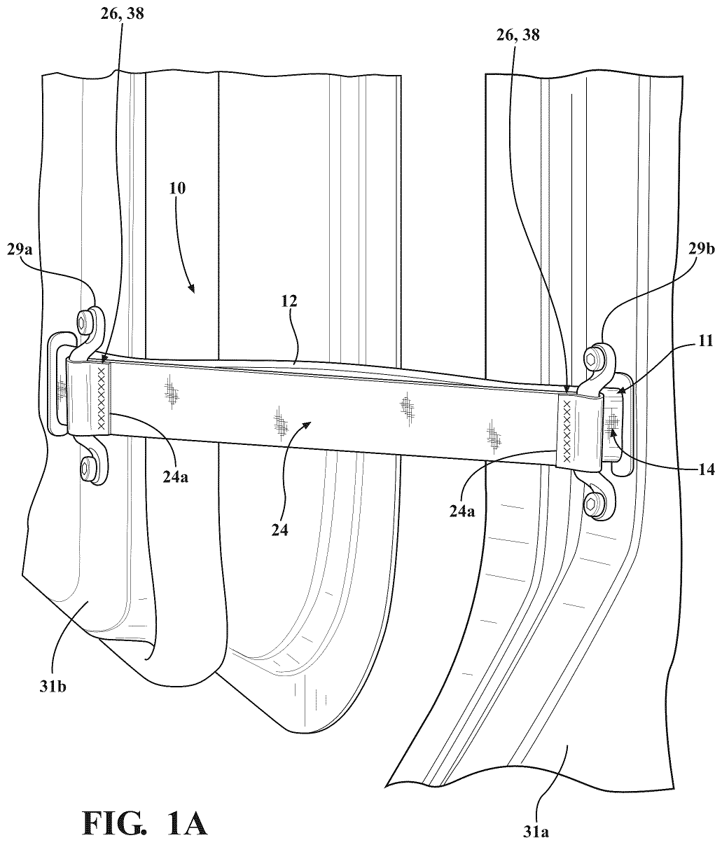

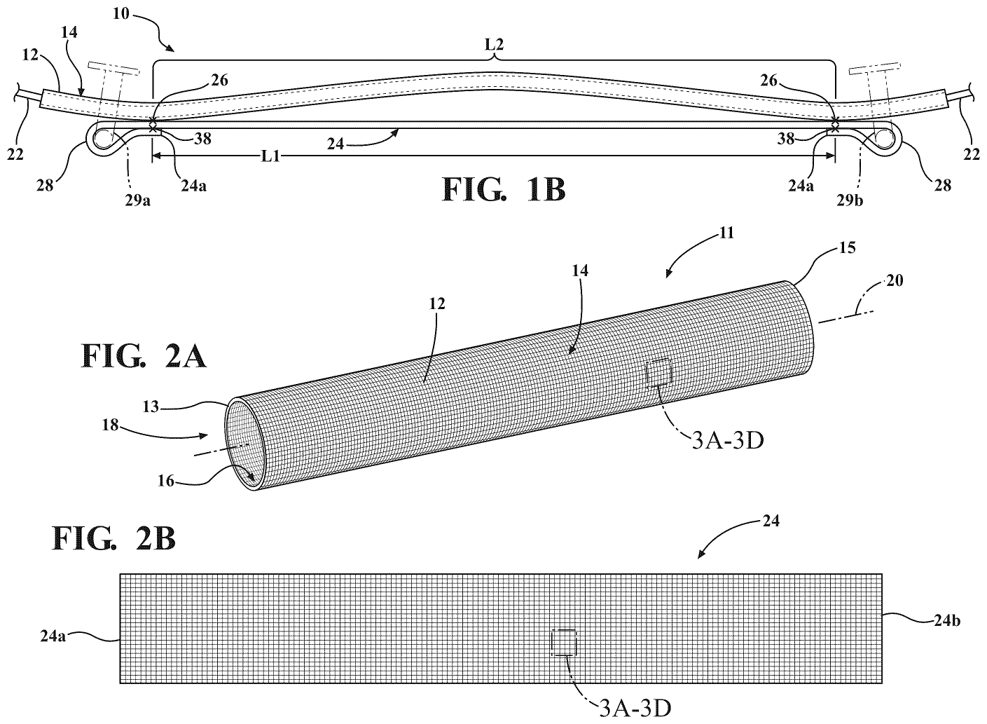

Referring in more detail to the drawings, FIGS. 1A and 1B show a protective sleeve and door strap assembly, also referred to as textile sleeve assembly 10, constructed in accordance with an aspect of the disclosure. The textile sleeve assembly 10 includes a protective tubular textile sleeve 11 having an elongate tubular textile wall 12 (FIG. 2A) with an outer surface 14 and an inner surface 16 bounding a cavity 18 extending a longitudinal central axis 20 between opposite ends 13, 15, with the cavity 18 being configured for routing and protecting an elongate member 22 therein, such as electrical member(s), including wires or wire harness, by way of example and without limitation. The textile sleeve assembly 10 further includes a generally flat wall of textile fabric, also referred to as textile strap, door strap, textile wall or textile fabric 24, (FIG. 2B) bonded to the outer surface 14 of the textile sleeve 11 via a plurality of weld joints, and shown by way of example as a pair of weld joints 26. The textile fabric 24 has a pair of attachment features 28 formed integrally as a monolithic piece of the textile fabric 24 for attachment to spaced apart attachment members 29a, 29b on a vehicle body 31a and a closure member, such as a passenger door 31b (FIG. 1A), respectively, of a vehicle. In the non-limiting embodiment illustrated, the opposite ends 13, 15 of the textile wall 12 extend beyond the pair of attachment features 28 of the textile fabric 24, by way of example and without limitation.

The wall 12 of the textile sleeve 11 can be woven with lengthwise extending warp yarns 30 extending generally parallel to the longitudinal central axis 20 and weft yarns, also commonly referred to as fill yarns 32, extending generally circumferentially about the longitudinal central axis 20 in generally transverse relation to the warp yarns 30. At least some or all of the warp yarns 30 and at least some or all of the weft yarns 32 are provided as ultrasonically weldable polymeric yarns, such as from polyester or nylon, by way of example and without limitation. The warp yarns 30 and weft yarns 32 can be provided, at least in part, including any suitable ultrasonically weldable polymeric monofilament and/or multifilament material, and in a presently preferred embodiment, entirely of multifilaments of polyester or nylon, by way of example and without limitation. Depending on the application needs, the textile sleeve 11 can be constructed having any suitable size, including length and diameter.

The textile fabric 24 of the strap can be woven with lengthwise extending warp yarns 34 extending generally parallel to the longitudinal central axis 20 and weft yarns, also commonly referred to as fill yarns 36, extending in generally transverse relation to the warp yarns 34. At least some or all of the warp yarns 34 and at least some or all of the weft yarns 36 are provided as ultrasonically weldable polymeric yarns, such as from polyester or nylon, by way of example and without limitation. The warp yarns 34 and weft yarns 36 can be provided, at least in part, including any suitable ultrasonically weldable polymeric monofilament and/or multifilament material, and in a presently preferred embodiment, entirely of multifilaments of polyester or nylon. In accordance with a presently preferred, non-limiting embodiment, the entirety of the yarns of the textile sleeve 11 and the textile fabric 24 are provided as ultrasonically weldable polyester or nylon, thereby maximizing the welded bond therebetween, and thus, the material type of the fabric of the textile sleeve assembly 10 is uniform and the same. The yarns can be entirely monofilaments, entirely multifilaments, or both.

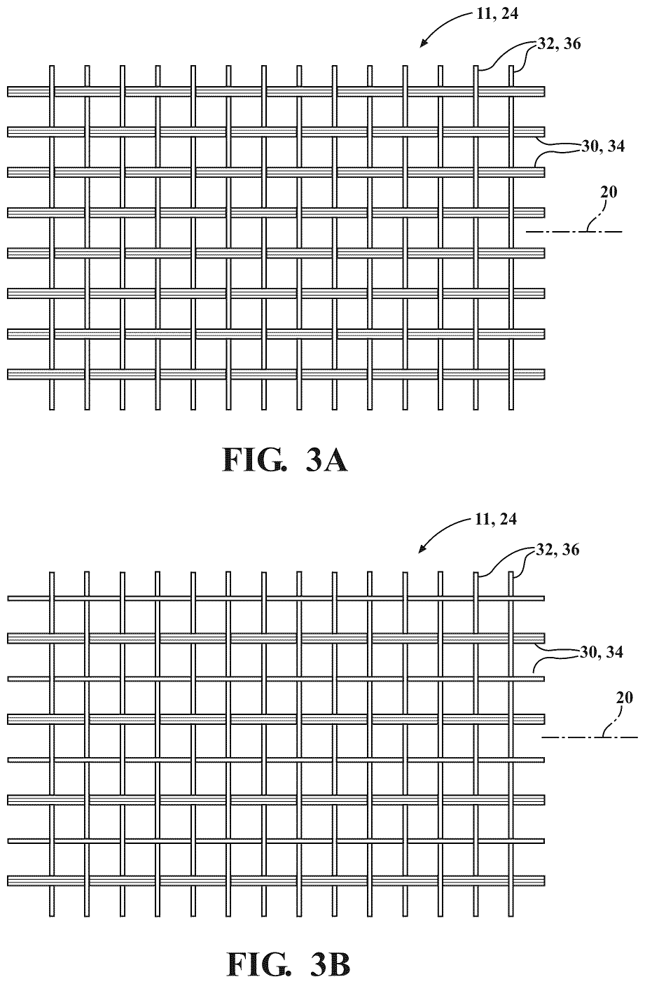

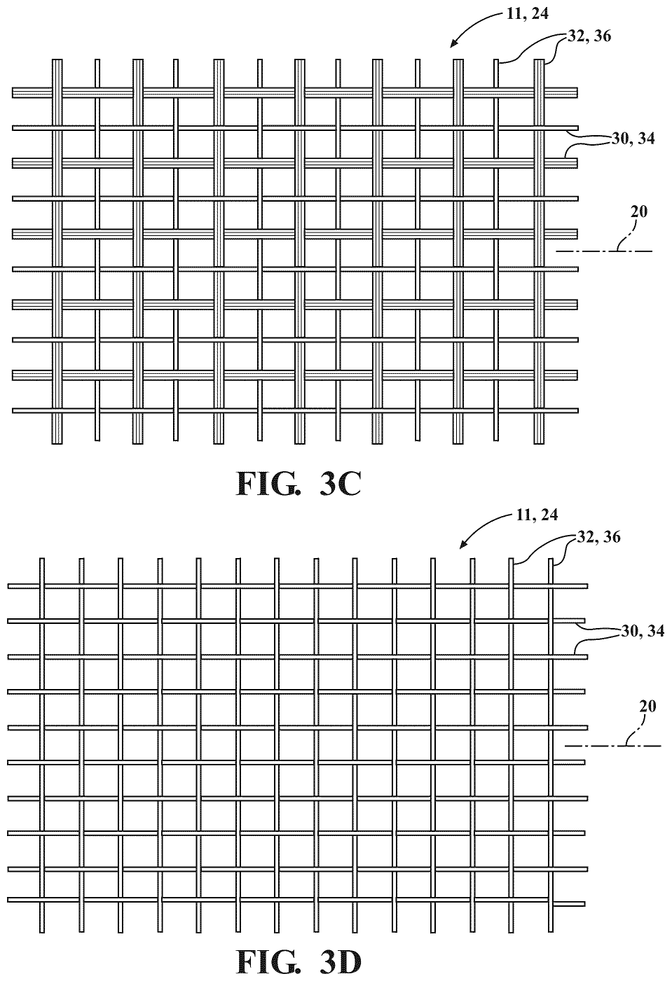

As shown in FIG. 3A, with reference to the textile sleeve 11 and the textile fabric 24, in accordance with one aspect of the disclosure, the respective weft yarns 32, 36 can be provided as all monofilaments of ultrasonically weldable material, while the respective warp yarns 30, 34 can be provided as all multifilaments. The warp multifilaments 30, 34 can be provided of any desired material, including entirely of extreme heat-resistant materials, such as fiberglass, ceramic, mineral yarn, nomex, by way of example and without limitation, thereby enhancing the thermal protection to the elongate member 22, and/or of ultrasonically weldable material, thereby enhancing the strength of the ultrasonically welded bond joints 26. As shown in FIG. 3B, with reference to the textile sleeve 11 and the textile fabric 24, in accordance with another aspect of the disclosure, the respective weft yarns 32, 36 can be provided as all monofilaments of ultrasonically weldable material, while the respective warp yarns 30, 34 can be provided as both monofilaments and multifilaments, such as in alternating relation with one another, by way of example and without limitation. The warp monofilaments can be provided of the same material as the weft monofilaments 32, 36, thereby facilitating forming the ultrasonically welded joints 26, while the warp multifilaments can be provided of any desired material, including entirely of extreme heat-resistant materials, such as fiberglass, ceramic, mineral yarn, nomex, by way of example and without limitation, thereby enhancing thermal protection properties of the sleeve 11, and/or of ultrasonically weldable material to further enhance the strength of bond at the weld joints 26. As shown in FIG. 3C, with reference to the textile sleeve 11 and the textile fabric 24, in accordance with another aspect of the disclosure, the respective weft yarns 32, 36 can be provided as both monofilaments and multifilaments and the respective warp yarns 30, 34 can be provided as both monofilaments and multifilaments. The weft and warp monofilaments can be provided as ultrasonically weldable material, thereby facilitating forming the ultrasonically welded joints 26, while the weft and warp multifilaments can be provided of any desired material, including entirely of extreme heat-resistant materials, such as fiberglass, ceramic, mineral yarn, nomex, by way of example and without limitation, thereby enhancing thermal protection properties of the sleeve 11, and/or of ultrasonically weldable material, thereby further facilitating forming and enhancing the strength of the ultrasonically welded bond joints 26. As shown in FIG. 3D, with reference to the textile sleeve 11 and the textile fabric 24, in accordance with another aspect of the disclosure, the respective weft yarns 32, 36 can be provided entirely of monofilaments and the respective warp yarns 30, 34 can be provided entirely of monofilaments, thereby maximizing the abrasion resistance of the sleeve 11. The weft monofilaments 32, 36 and warp monofilaments 30, 34 can be provided entirely of ultrasonically weldable material, by way of example and without limitation, thereby maximizing the strength of the ultrasonically welded joints 26.

The attachment features 28 of the textile fabric 24 are formed and provided as reverse folded, circumferentially closed hoops, also referred to as loops, of the textile fabric 24. Opposite ends 24a of the textile fabric 24, corresponding with an end of the reverse folded loops 28, are ultrasonically welded to the textile fabric 24 at weld joints 38. The weld joints 38 can be formed as ultrasonically welded weld joints 38, as discussed above for weld joints 26, and can extend across the entire width of the textile fabric 24 for maximum strength of bond of the weld joints 38. Weld joints 38 can be formed in the same welding operation as weld joints 26, and thus, can be formed as a single weld joint 26, 38, as shown.

The loops 28 are each sized for receipt of the attachment members 29a, 29b therethrough, such as a pin or other member fixed to the vehicle body 31a (FIG. 1A) of the vehicle and a pin or other member fixed to the closure member 31b of the vehicle. As such, the textile sleeve assembly 10 is held in a desired location by the loops 28 of the textile fabric 24 extending about their respective attachment members 29a, 29b in fixed relation therewith. The textile fabric 24 functions to prevent tensile stress from being transferred to and being applied to the wall 12 of the textile sleeve 11, and thus, prevents tensile stress from being transferred to the elongate member 22 contained in the cavity 18 of the textile sleeve 11, even when the closure member 31b is moved suddenly to a fully opened extent. As such, the textile fabric 24 functions as a mechanical door check or strap to limit the extent to which the closure member 31 can be moved to its maximum, fully opened position, thereby defining the maximum open position, and further, to limit or negate tensile force from being applied to the textile sleeve 11 and the elongate member 22, thereby preventing inadvertent damage to both. Accordingly, the textile sleeve assembly 10 not only functions as a protective sleeve 11 to protect the elongate member 22 against damage, but also as a mechanical door check assembly to provide a hard stop limit for closure member 31b in its fully open position.

In accordance with an aspect of the disclosure, textile sleeve assembly 10 is constructed to ensure any tensile force applied along the length of the textile fabric 24, while opening the closure member 31, is not applied to the textile sleeve 11, nor to the elongate member 22. The avoidance of tension being applied to the textile sleeve 11 and to the elongate member 22 is facilitated by the location of the weld joints 26, shown as a pair of weld joints 26, also referred to as a first weld joint 26 and a second weld joint 26, being spaced from one another a first distance, also referred to as first length L1, along the textile fabric 24, while in a straightened configuration, and along the longitudinal central axis 20 extending between the pair of weld joints 26, such that the first length L1 is less than a corresponding second distance, also referred to as second length L2, of a portion 11a of the textile sleeve 11 extending from one of the pair of weld joints 26 to the other of the pair of weld joints 26. Accordingly, the second length L2 is greater than the first length L1. Accordingly, as the textile fabric 24 is placed under tension in the straightened configuration via oppositely directed pulling forces being applied by the attachment members 29a, 29b to the attachment features 28, such as when the closure member 31b is in a fully opened position, the portion 11a of the textile sleeve 11 remains longer than the length L1 of the tensioned textile fabric 24 extending between the weld joints 26, thereby being in a “slack” condition and preventing the tension within the textile fabric 24 from being transferred to the textile sleeve 11, thus, negating the textile sleeve 11 and portion 11a thereof from being placed under tension. Accordingly, during use, the entirety of the textile sleeve 11 extending from one end 13 to the opposite end 15 remains under a non-tensioned, “slack” condition free from tension, and thus, tension is prevented from being transferred to or otherwise applied to the elongate member 22 contained within the cavity 18 of the textile sleeve 11, thereby maximizing the useful life of the elongate member 22.

In accordance with another aspect of the disclosure, a method of constructing a protective sleeve and door strap assembly 10 is provided. The method includes, interlacing yarn to form a tubular textile wall 12 having an outer surface 14 and an inner surface 16 bounding a cavity 18 extending a longitudinal central axis 20 for routing and protecting an elongate member 22 therein. Further, interlacing yarn to form a flat wall 24 of textile fabric extending lengthwise between opposite ends, reverse folding the opposite ends into engagement with the flat wall 24 of textile fabric and bonding the opposite ends to the flat wall of textile fabric to form pair of loops 28 configured for attachment to spaced apart attachment members 29a, 29b on a vehicle body and a closure member of a vehicle; and welding the flat wall 24 of textile fabric to the outer surface 14 of the tubular textile wall 12 via a plurality of weld joints 26.

The method can further include forming at least a pair of the plurality of weld joints 26 including a first weld joint 26 and a second weld joint 26 spaced from one another along the textile flat wall of textile fabric a first length L1, and forming a portion of the tubular textile wall 12 extending from the first weld joint 26 to the second weld joint 26 having a second length L2, wherein the second length L2 is greater than the first length L1, thereby ensuring the portion of the tubular textile wall 12 extending from the first weld joint 26 to the second weld joint 26 is always maintained in a non-tensioned, slack state, thereby preventing tension from being transferred from the flat wall 24 of textile fabric to the elongate member 22.

Obviously, many modifications and variations of the present invention are possible in light of the above teachings. It is contemplated that all features of all claims and of all embodiments can be combined with each other, so long as such combinations would not contradict one another. It is, therefore, to be understood that within the scope of the appended claims, the invention may be practiced otherwise than as specifically described.

What is claimed is:

1. A textile sleeve assembly, comprising:
a tubular textile wall with an outer surface and an inner surface bounding a cavity extending a longitudinal central axis for routing and protecting an elongate member therein; and
a textile fabric bonded to the outer surface of the tubular textile wall via a plurality of weld joints, the textile fabric having a pair of attachment features for attachment to spaced apart attachment members on a vehicle body and a closure member of a vehicle.

2. The textile sleeve assembly of claim 1, wherein the tubular textile wall includes warp yarns extending generally parallel to the longitudinal central axis and weft yarns extending generally transversely to the warp yarns.

3. The textile sleeve assembly of claim 2, wherein the textile fabric includes warp yarns extending generally parallel to the longitudinal central axis and weft yarns extending generally transversely to the warp yarns, wherein at least some of the yarns of the tubular textile wall and the textile fabric are provided as ultrasonically weldable material.

4. The textile sleeve assembly of claim 3, wherein the entirety of the yarns of at least one of the tubular textile wall and the textile fabric are provided as ultrasonically weldable material.

5. The textile sleeve assembly of claim 4, wherein the entirety of the yarns of the tubular textile wall and the textile fabric are provided as weldable material.

6. The textile sleeve assembly of claim 3, wherein the at least some of the yarns of the tubular textile wall and the textile fabric are provided as polyester or nylon.

7. The textile sleeve assembly of claim 1, wherein the pair of attachment features are circumferentially closed loops formed by material of the textile fabric reverse folded back into bonded relation with the textile fabric.

8. The textile sleeve assembly of claim 7, wherein the textile fabric forming the pair of circumferentially closed loops is ultrasonically welded to itself by at least some of the plurality of weld joints.

9. The textile sleeve assembly of claim 1, wherein the opposite ends of the tubular textile wall extend beyond the pair of attachment features of the textile fabric.

10. The textile sleeve assembly of claim 1, wherein the plurality of weld joints includes a pair of weld joints spaced from one another along the textile fabric a first length, and a portion of the tubular textile wall extending from one of the pair of weld joints to the other of the pair of weld joints over a second length, wherein the second length is greater than the first length.

11. The textile sleeve assembly of claim 10, wherein the pair of attachment features are circumferentially closed loops formed by material of the textile fabric reverse folded back into bonded relation with the textile fabric.

12. The textile sleeve assembly of claim 11, wherein the textile fabric forming the pair of circumferentially closed loops is ultrasonically welded to itself.

13. The textile sleeve assembly of claim 11, wherein the plurality of weld joints are ultrasonically formed weld joints.

14. The textile sleeve assembly of claim 13, wherein the tubular textile wall and the textile fabric include ultrasonically weldable material bonded together by the ultrasonically formed weld joints.

15. The textile sleeve assembly of claim 11, wherein the tubular textile wall and the textile fabric are woven.

16. A protective sleeve and door strap assembly, comprising:
a tubular textile wall with an outer surface and an inner surface bounding a cavity extending a longitudinal central axis for routing and protecting an elongate member therein; and
a textile door strap bonded to the outer surface of the tubular textile wall via a plurality of weld joints, the textile door strap having a pair of attachment features configured for attachment to spaced apart attachment members on a vehicle body and a closure member of a vehicle.

17. The protective sleeve and door strap assembly of claim 16, wherein the plurality of weld joints includes a first weld joint and a second weld joint spaced from one another along the textile door strap a first length, and a portion of the tubular textile wall extending from the first weld joint to the second weld joint over a second length, wherein the second length is greater than the first length.

18. The protective sleeve and door strap assembly of claim 17, wherein the pair of attachment features are circumferentially closed loops.

19. A method of constructing a protective sleeve and door strap assembly, comprising:
interlacing yarn to form a tubular textile wall having an outer surface and an inner surface bounding a cavity extending a longitudinal central axis for routing and protecting an elongate member therein;
interlacing yarn to form a flat wall of textile fabric extending lengthwise between opposite ends;
reverse folding the opposite ends into engagement with the flat wall of textile fabric and bonding the opposite ends to the flat wall of textile fabric to form pair of loops configured for attachment to spaced apart attachment members on a vehicle body and a closure member of a vehicle; and
welding the flat wall of textile fabric to the outer surface of the tubular textile wall via a plurality of weld joints.

20. The method of claim 19, further including forming at least a pair of the plurality of weld joints including a first weld joint and a second weld joint spaced from one another along the textile flat wall of textile fabric a first length, and forming a portion of the tubular textile wall extending from the first weld joint to the second weld joint having a second length, wherein the second length is greater than the first length.
